(19) United States
(12) Patent Application Publication
(10) Pub. No.: US 2008/0169027 A1
(43) Pub. Date: Jul. 17, 2008

(54) FLUID FILLING APPARATUS AND METHOD OF FILLING THROUGH HOLES WITH FLUID

(75) Inventors: Fumihiko TOKURA, Kawasaki (JP); Mitsuo TAKEUCHI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/036,638

(22) Filed: Feb. 25, 2008

Related U.S. Application Data
(63) Continuation of application No. PCT/JP2005/015285, filed on Aug. 23, 2005.

(51) Int. Cl. F17D 3/00; F16L 3/01

(52) U.S. Cl. 137/13; 137/561 R

(57) ABSTRACT

A fluid filling apparatus allows a stage to receive a plate on a fluid spreading over a surface of the stage. A driving mechanism drives the plate along the surface of the stage. Relative movement is induced between through holes, formed in the plate, and the fluid. Since the through holes open to the fluid, the openings of the through holes are rubbed against the fluid. The edges of the openings serve to scrape the fluid. The scraped fluid penetrates into the through holes. The through holes are thus simultaneously filled with the fluid in a significantly facilitated manner. In addition, since the through holes can be filled with the solder material without application of a large pressure, a large-scale apparatus is not required. Moreover, the alignment of the through holes is not required.

### BACKGROUND OF THE INVENTION

1. Field of the Invention

The present invention relates to a fluid filling apparatus and a method of filling through holes with a fluid. The apparatus and method is employed to fill the through holes, formed in a plate, with a fluid or filling material having viscosity.

2. Description of the Prior Art

Japanese Patent Application Publication No. 2001-217538 discloses a fluid filling apparatus employed to fill through holes, formed in a printed wiring board, with a filling paste, for example. The fluid filling apparatus includes a tank storing the filling paste. The tank receives the back surface of the printed wiring board. Through bores are defined in the top plate of the tank. A piston is incorporated in the tank to apply pressure. The through holes of the printed wiring board are aligned with the through bores of the tank. The piston serves to urge the filling paste out of the through bores. The through holes of the printed wiring board are in this manner filled with the filling paste.

An increased depth of the through holes in the printed wiring board requires an increased pressure of the piston for filling the through holes with the filling paste. A large-scale apparatus is required. Moreover, the through holes of the printed wiring board and the through bores of the tank inevitably deviate from designed positions based on machining error. In the case where the number of the through holes is increased, it is impossible to accurately align the through holes of the printed wiring board with the through bores of the tank. All the through holes of the printed wiring board cannot thus completely be filled with the filling paste.

### SUMMARY OF THE INVENTION

It is accordingly an object of the present invention to provide a fluid filling apparatus and a method of filling employed to simultaneously fill through holes with a fluid in a significantly facilitated manner.

According to a first aspect of the present invention, there is provided a fluid filling apparatus comprising: a stage defining a predetermined surface receiving a fluid spreading over the predetermined surface of the stage for receiving a plate; and a driving mechanism driving the plate along the predetermined surface of the stage for relative movement between the fluid and through holes formed in the plate, the through holes opening to the fluid.

When the fluid is filled in the through holes, the fluid filling apparatus allows the stage to receive the plate on the fluid spreading over the predetermined surface of the stage. The driving mechanism drives the plate along the predetermined surface of the stage. Relative movement is induced between the through holes and the fluid. Since the through holes of the plate open to the fluid, the openings of the through holes are rubbed against the fluid. The edges of the openings serve to scrape the fluid. The scraped fluid penetrates into the through holes. The through holes are thus simultaneously filled with the fluid in a significantly facilitated manner. In addition, since the through holes can be filled with the solder material without application of a large pressure, a large-scale apparatus is not required. Moreover, the alignment of the through holes is not required.

Depressions may be defined in the predetermined surface of the stage in the fluid filling apparatus. The fluid is stored in the depressions. The solder material is prevented from coming out of a space between the plate and the stage to the utmost. The solder material of a sufficient amount is thus supplied to the openings of the through holes. The through holes are filled with the fluid in an efficient manner.

In this case, the stage may be made of an elastic material. The fluid filling apparatus of this type allows the depressions to store the fluid. Moreover, the stage elastically deforms around the depressions when the relative movement induced between the through holes and the stage. Such an elastic deformation serves to push the solder material out of the depressions. The openings of the through holes are supplied with the solder material of a sufficient amount. The through holes are filled with the fluid in an efficient manner.

A bent section may be defined in at least one of the through holes of the plate utilized for the fluid filling apparatus. The aforementioned fluid filling apparatus allows the edges of the through holes at the openings to scrape the fluid. The bent section is thus filled with the fluid in a facilitated manner.

According to a second aspect of the present invention, there is provided a fluid filling apparatus comprising: a stage defining a predetermined surface receiving a fluid spreading over the predetermined surface of the stage for receiving a plate; an urging member urging the plate toward the predetermined surface of the stage; and a driving mechanism driving the stage for relative movement between the fluid and through holes formed in the plate, the through holes opening to the fluid.

When the fluid is filled in the through holes, the fluid filling apparatus allows the stage to receive the plate on the fluid spreading over the predetermined surface of the stage. The driving mechanism drives the stage relative to the plate. Relative movement is induced between the plate and the fluid. Since the through holes of the plate open to the fluid, the openings of the through holes are rubbed against the fluid. The edges of the openings serve to scrape the fluid. The scraped fluid penetrates into the through holes. The through holes are thus simultaneously filled with the fluid in a significantly facilitated manner. In addition, since the through holes can be filled with the solder material without application of a large pressure, a large-scale apparatus is not required. Moreover, the alignment of the through holes is not required.

According to a third aspect of the present invention, there is provided a method of filling, comprising: setting a plate on a fluid spreading over the surface of a stage; and generating relative movement between the fluid and through holes formed in the plate while urging the plate toward the surface of the stage, the through holes opening to the fluid.

When the fluid is filled in the through holes, the plate is received on the fluid spreading over the surface of the stage. The plate is urged against the surface of the stage. Relative movement is induced between the through holes of the plate and the fluid. Since the through holes of the plate open to the fluid, the openings of the through holes are rubbed against the fluid. The edges of the openings serve to scrape the fluid. The scraped fluid penetrates into the through holes. The through holes are thus simultaneously filled with the fluid in a significantly facilitated manner.

According to a fourth aspect of the present invention, there is provided a method of making a product, comprising: setting a solid member on a filling material having a predetermined viscosity; and generating relative movement between the filling material and through holes formed in the solid member while urging the solid member against the filling material, the through holes opening to the filling material.

When the filling material having viscosity is filled in the through holes, the solid member is received on the filling material. The solid member is urged against the filling material. Since the through holes of the solid member open to the filling material, the openings of the through holes are rubbed against the filling material. The edges of the openings serve to scrape the filling material. The scraped filling material penetrates into the through holes. The through holes are thus simultaneously filled with the filling material in a significantly facilitated manner.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a view schematically illustrating a specific example of a fluid filling apparatus according to an embodiment of the present invention;

FIG. 2 is a perspective view schematically illustrating a flat plate;

FIG. 3 is a sectional view taken along the line 3-3 in FIG. 2;

FIG. 4 is a view schematically illustrating the flat plate mounted on a movable member;

FIG. 5 is a view schematically illustrating the flat plate urged against a solder paste on a stage;

FIG. 6 is a view schematically illustrating the movement of the flat plate in a first direction along the upper surface of the stage;

FIG. 7 is a view schematically illustrating the movement of the flat plate in a second direction opposite to the first direction along the upper surface of the stage;

FIG. 8 is a view schematically illustrating the solder paste overflowing on the front surface of the flat plate from through holes;

FIG. 9 is a view schematically illustrating another specific example of the fluid filling apparatus;

FIG. 10 is a view schematically illustrating another specific example of the fluid filling apparatus;

FIG. 11 is a view schematically illustrating the movement of a flat plate along the upper surface of a stage;

FIG. 12 is a view schematically illustrating another specific example of the fluid filling apparatus;

FIG. 13 is a view schematically illustrating the movement of a flat plate along the upper surface of a stage;

FIG. 14 is a view schematically illustrating another specific example of the fluid filling apparatus; and

FIG. 15 is a sectional view, corresponding to FIG. 3, illustrating another specific example of the flat plate.

### DESCRIPTION OF THE PREFERRED EMBODIMENTS

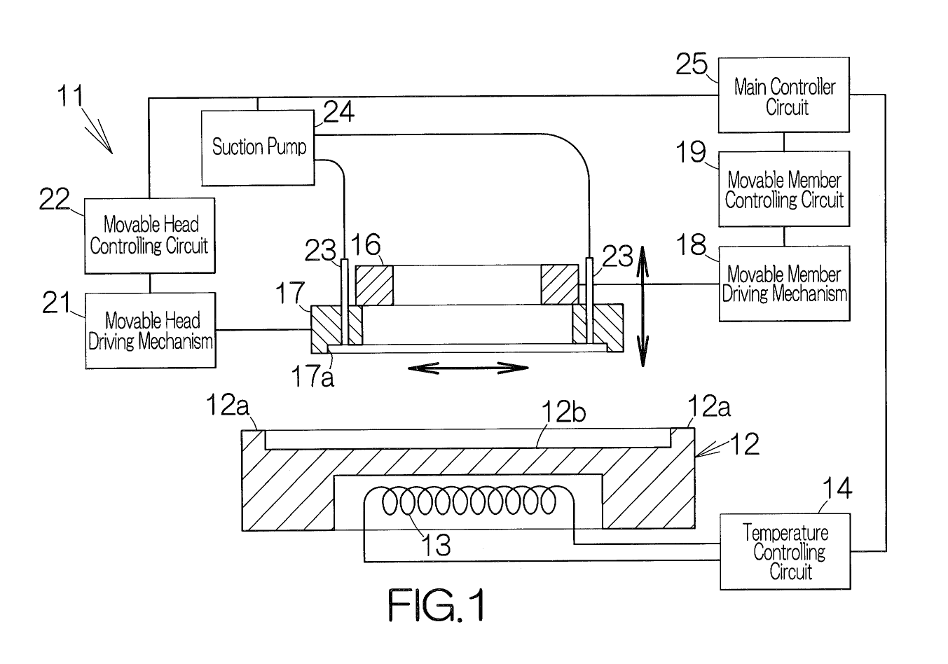

FIG. 1 schematically illustrates a fluid filling apparatus 11 according to an embodiment of the present invention. The fluid filling apparatus 11 includes a stage 12 defining an upper surface within a horizontal plane. A surrounding wall 12a stands upright from the outer peripheral edge of the upper surface of the stage 12. A flat surface 12b is thus defined in the upper surface of the stage 12a at a position surrounded by the surrounding wall 12a. A fluid is received on the flat surface 12b as described later. The fluid includes a filling material having viscosity.

A heat generating body, namely an electrothermal coil 13, is opposed to the back surface of the stage 12. The electrothermal coil 13 generates heat in response to electric current running through the electrothermal coil 13. The stage 12 is heated in this manner. A temperature controlling circuit 14 is connected to the electrothermal coil 13. The temperature controlling circuit 14 adjusts the amount of the electric current running through the electrothermal coil 13. The temperature controlling circuit 14 in this manner serves to control the temperature of the electrothermal coil 13, namely of the stage 12.

The fluid filling apparatus 11 includes a movable member 16 and a movable head 17 coupled to the movable member 16 for relative movement. The movable head 17 may be coupled to the lower end of the movable member 16, for example. The movable member 16 and the movable head 17 each may be formed in the shape of a frame, for example. The lower surface of the movable head 17 is opposed to the flat surface 12b of the stage 12.

A movable member driving mechanism 18 is connected to the movable member 16. A movable member controlling circuit 19 is connected to the movable member driving mechanism 18. The movable member controlling circuit 19 is designed to supply an electric signal to the movable member driving mechanism 18. The movable member driving mechanism 18 drives the movable member 16 and the movable head 17 in the vertical direction perpendicular to the flat surface 12b of the stage 12 based on the supplied electric signal. The movable member driving mechanism 18 in this manner controls the urging force of the movable head 17 against the flat surface 12b of the stage 12.

A movable head driving mechanism 21 is connected to the movable head 17. A movable head controlling circuit 22 is connected to the movable head driving mechanism 21. The movable head controlling circuit 22 is designed to supply an electric signal to the movable head driving mechanism 21. The movable head driving mechanism 21 drives the movable head 17 relative to the movable member 16. The movable head 17 is in this manner allowed to move in the horizontal direction, perpendicular to the vertical direction, in parallel with the flat surface 12b of the stage 12. Here, the movable head 17 reciprocates in the horizontal direction.

A receiving depression 17a is formed in the lower surface of the movable head 17. A solid member such as a substrate, namely a flat plate, is received in the receiving depression 17a as described later. The contour of the receiving depression 17a may correspond to the contour of the flat plate. Suction hoses 23 are connected to the receiving depression 17a. A suction pump 24 is connected to the suction hoses 23. When the flat plate is received in the receiving depression 17a, the suction pump 24 operates to generate suction at the tip ends of the suction hoses 23. The flat plate is held on the movable head 17 in this manner.

A main controller circuit 25 is connected to the temperature controlling circuit 14, the movable member controlling circuit 19, the movable head controlling circuit 22 and the suction pump 24. The main controller circuit 25 is designed to control the operation of the fluid filling apparatus 11 based on a predetermined program. The main controller circuit 25 supplies predetermined control signals to the temperature controlling circuit 14, the movable member controlling circuit 19, the movable head controlling circuit 22 and the suction pump 24, respectively. The operation of the temperature controlling circuit 14, the movable member controlling circuit 19, the movable head controlling circuit 22 and the suction pump 24 is controlled based on the supplied control signals.

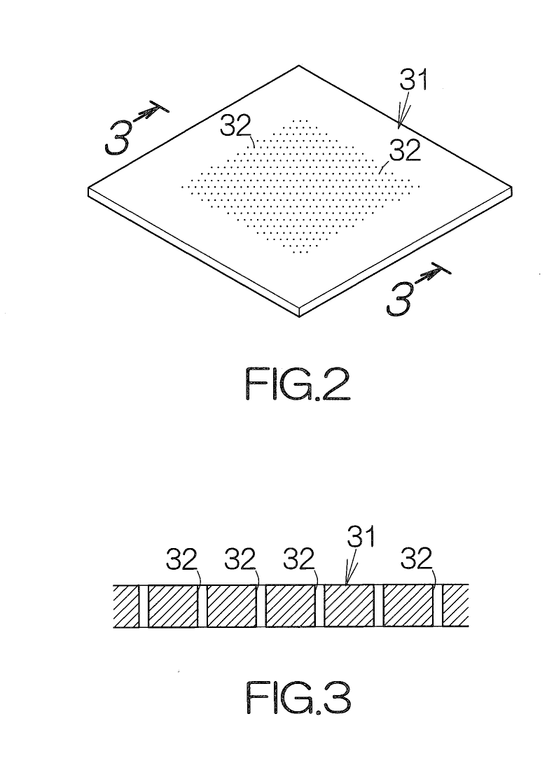

As shown in FIG. 2, the flat plate 31 is formed in the shape of a rectangular, for example. The flat plate 31 is a glass plate, for example. The thickness of the flat plate 31 is set at 400 μm approximately, for example. Referring also to FIG. 3, 2,000 through holes 32 are formed in the flat plate 31 at predetermined intervals, for example. The individual through holes 32 penetrate through the flat plate 31 in the direction perpendicular to the front surface of the flat plate 31. The through holes 32 extend in parallel with one another. The through holes 32 are set to have a circular cross-section, for example. The circular cross-section has the diameter of 20 μm approximately, for example.

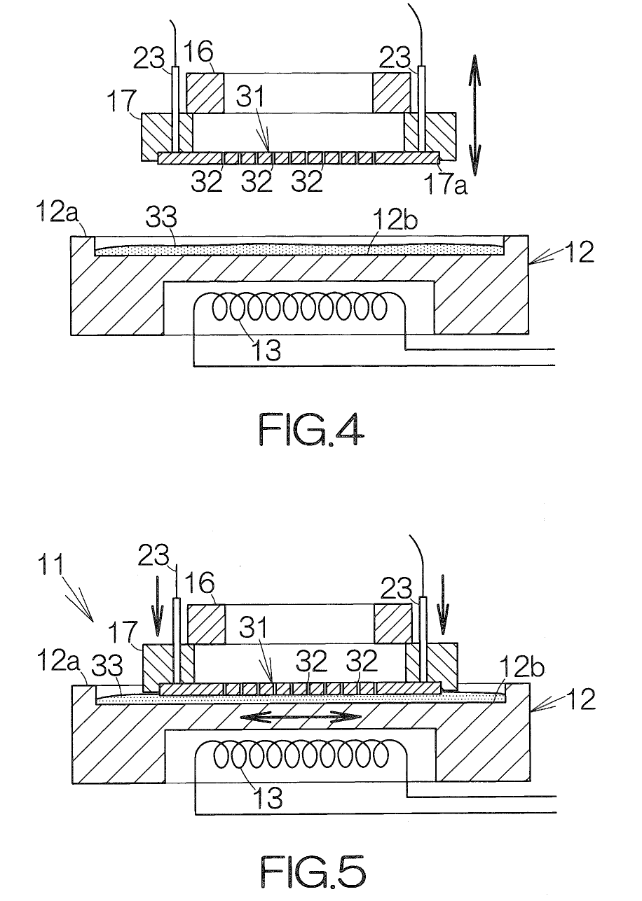

Now, assume that the through holes 32 of the flat plate 31 are filled with a fluid. The flat plate 31 is first mounted on the movable head 17, as shown in FIG. 4. The main controller circuit 25 supplies a control signal to the suction pump 24. The suction pump 24 operates based on the control signal. The flat plate 31 is thus attached to the tip ends of the suction hoses 23 based on the suction. The flat plate 31 is in this manner held in the receiving depression 17a of the movable head 17. The back surface of the flat plate 31 is opposed to the flat surface 12b of the stage 12.

A solder material 33 as a fluid is placed on the flat surface 12b of the stage 12. An electrically-conductive material such as an alloy of zinc and aluminum or an alloy of zinc, tin and aluminum is employed as the solder material 33. The electrothermal coil 13 serves to heat the solder material 33 on the flat surface 12b. The stage 12 is heated up to the melting point of the solder material 33. The solder material 33 gets molten. The solder material 33 in fluid state exhibits a predetermined viscosity. The surrounding wall 12a serves to prevent leakage of the solder material 33 out of the peripheral edge of the stage 12.

The main controller circuit 25 supplies a control signal to the movable member controlling circuit 19. The movable member controlling circuit 19 supplies an electric signal to the movable member driving mechanism 18 in response to the supplied control signal. The movable member driving mechanism 18 drives the movable member 16 and the movable head 17 downward in the vertical direction toward the flat surface 12b of the stage 12 based on the supplied electric signal. The movable member 16 and the movable head 17 are then held at a predetermined position. As shown in FIG. 5, the back surface of the flat plate 31 is received on the solder material 33 on the flat surface 12b of the stage 12. The flat plate 31 is in this manner positioned on the solder material 33.

A predetermined urging force is applied to the movable member 16, namely the movable head 17, based on the electric signal supplied from the movable member controlling circuit 19, so that the movable head 17 is urged against the stage 12, namely the solder material 33. The movable head 17 in this manner serves as an urging member according to the present invention. In this case, the through holes 32 of the flat plate 31 open at positions adjacent the solder material 33. The openings of the through holes 32 contact the solder material 33. When the flat plate 31 is urged against the solder material 33 based on the urging force of the movable head 17, the solder material 33 enter the respective through holes 32.

The main controller circuit 25 then supplies a control signal to the movable head controlling circuit 22. The movable head controlling circuit 22 supplies an electric signal to the movable head driving mechanism 21 based on the supplied control signal. The movable head driving mechanism 21 drives the movable head 17 in the horizontal direction along the flat surface 12b of the stage 12 based on the supplied electric signal. The movable head 17 thus linearly moves in the horizontal direction. The urging force of the movable head 17 is maintained in the vertical direction based on the electric signal from the movable member controlling circuit 19. Likewise, the electrothermal coil 13 simultaneously serves to keep the temperature of the solder material 33 at a level equal to or higher than the melting point.

As shown in FIG. 6, the movable head 17 is driven to move in a first direction D1 in the horizontal direction. The stage 12 is set fixed. This horizontal movement of the movable head 17 generates relative movement between the flat plate 31 and the stage 12, namely the solder material 33. The openings 32a of the through holes 32 are rubbed against the solder material 33 during the relative movement. The edges of the through holes 32 at the openings 32a scrape off the solder material 33. The scraped solder material 33 thus penetrates into the through holes 32.

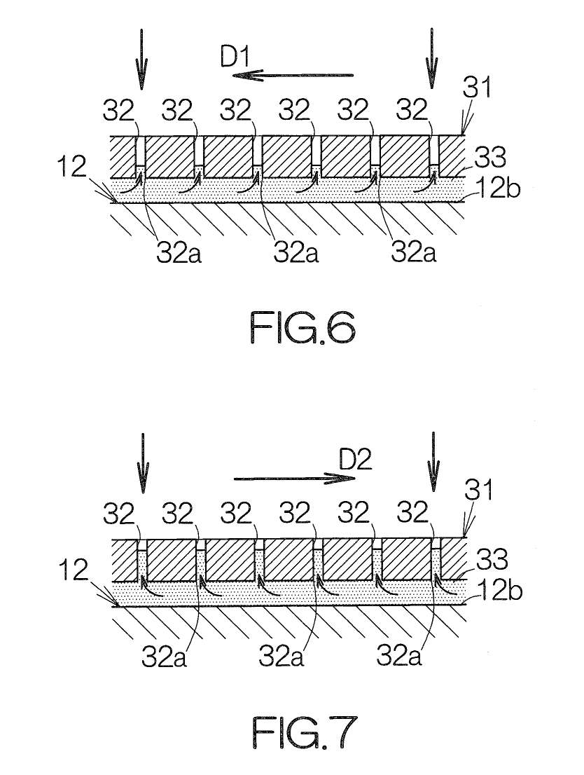

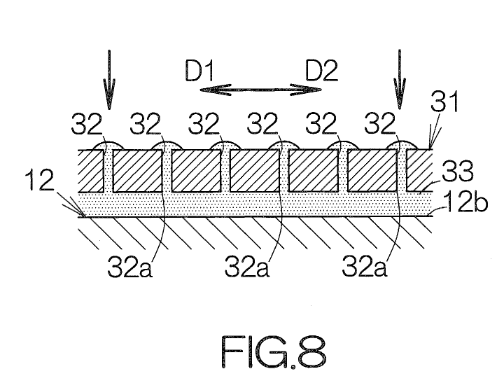

The movable head 17 is then driven to move in a second direction D2 opposite to the first direction D1 in the horizontal direction, as shown in FIG. 7. Relative movement is induced between the flat plate 31 and the solder material 33 in the same manner as described above. The openings 32a of the through holes 32 are rubbed against the solder material 33. The edges of the through holes 32 at the openings 32a again scrape off the solder material 33. The scraped solder material 33 penetrates into the through holes 32. The movable head 17 alternately moves in the first and second directions D1, D2.

As shown in FIG. 8, the solder material 33 eventually overflows on the front surface of the flat plate 31 from the through holes 32. The through holes 32 are completely filled with the solder material 33. The flat plate 31 is then detached from the movable head 17. The solder material 33 overflowing from the through holes 32 is removed from the front and back surfaces of the flat plate 31. The solder material 33 is then cooled within the through holes 32 so that the solder material 33 gets cured or hardened in the through holes 32. The through holes 32 are filled with an electrically-conductive material in this manner. The flat plate 31 is utilized to connect semiconductor chips to each other, for example. In this case, the solder material 33 is utilized as a wiring.

The fluid filling apparatus 11 allows relative movement between the flat plate 31 and the solder material 33 when the through holes 32 are filled with the solder material 33. Since the through holes 32 open to the solder material 33, the openings 32a of the through holes 32 are rubbed against the solder material 33. The edges of the through holes 32 at the openings 32a scrape off the solder material 33. The scraped solder material 33 penetrates into the through holes 32. All the through holes 32 are thus simultaneously filled with the solder material 33 in a significantly facilitated manner. In addition, since the through holes 32 can be filled with the solder material 33 without application of a large pressure, a large-scale apparatus is not required. Moreover, the flat plate 31 is merely received on the solder material 33 without alignment or positioning of the through holes 32.

The fluid filling apparatus 11 may allow the movable head 17 to rotate relative to the movable member 16 around a predetermined rotation axis, not shown. The rotation axis may be defined on a vertical axis perpendicular to the flat surface 12b of the stage 12. The rotation of the movable head 17 generates relative movement between the through holes 32 of the flat plate 31 and the stage 12, namely the solder material 33. The openings 32a of the through holes 32 are rubbed against the solder material 33. The edges of the through holes 32 at the openings 32a thus scrape off the solder material 33. All the through holes 32 are in this manner simultaneously filled with the solder material 33 in a significantly facilitated manner, in the same manner as described above.

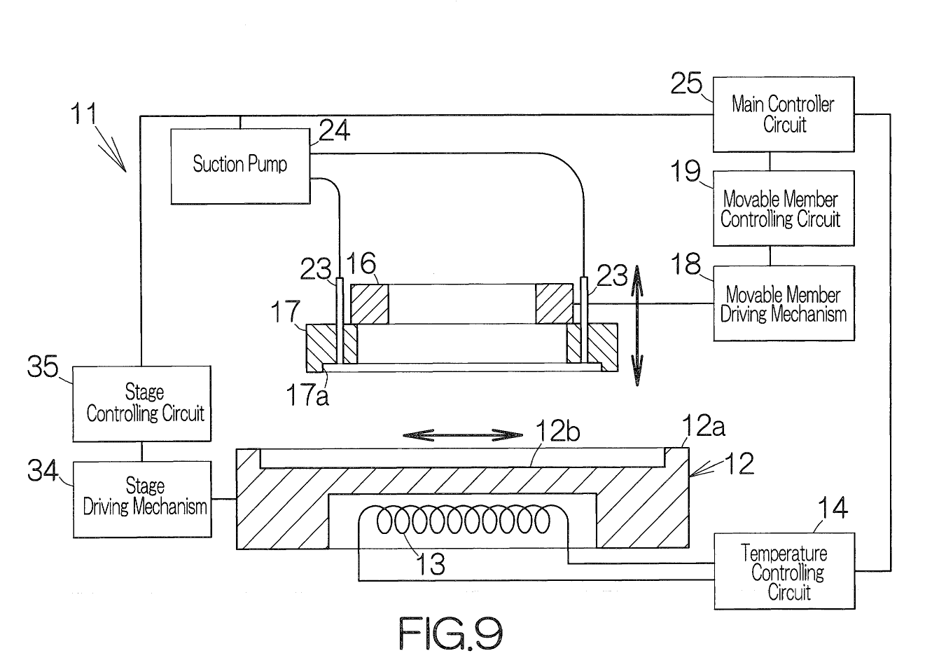

As shown in FIG. 9, a stage driving mechanism 34 may be connected to the stage 12. A stage controlling circuit 35 is connected to the stage driving mechanism 34. The main controller circuit 25 is connected to the stage controlling circuit 35. In this case, the aforementioned movable head driving mechanism 21 and the movable head controlling circuit 22 may be omitted. The stage driving mechanism 34 drives the stage 12 for horizontal linear movement or rotational movement relative to the movable head 17, namely the flat plate 31. The movable member controlling circuit 19 may allow the movable member 16 or the movable head 17 to solely move in the vertical direction. Like reference numerals are attached to the structure or components equivalent to those of the aforementioned embodiment.

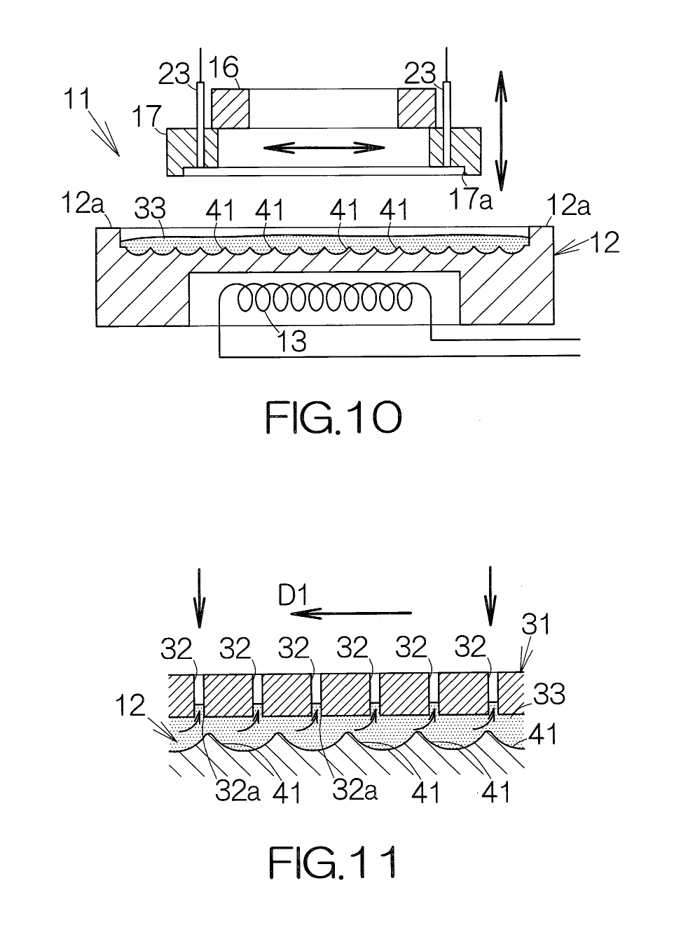

As shown in FIG. 10, depressions 41 may be defined on the upper surface of the stage 12. The depression 41 may be elongated grooves extending in a direction perpendicular to the reciprocating movement of the stage 12, for example. The elongated grooves may be formed in parallel with one another. As shown in FIG. 11, the solder material 33 is stored in the respective depressions 41. The solder material 33 is prevented from coming out of a space between the flat plate 31 and the stage 12 to the utmost. The solder material 33 of a sufficient amount can thus be supplied to the openings 32a of the through holes 32. The depressions 41 may be concentric elongated grooves, for example.

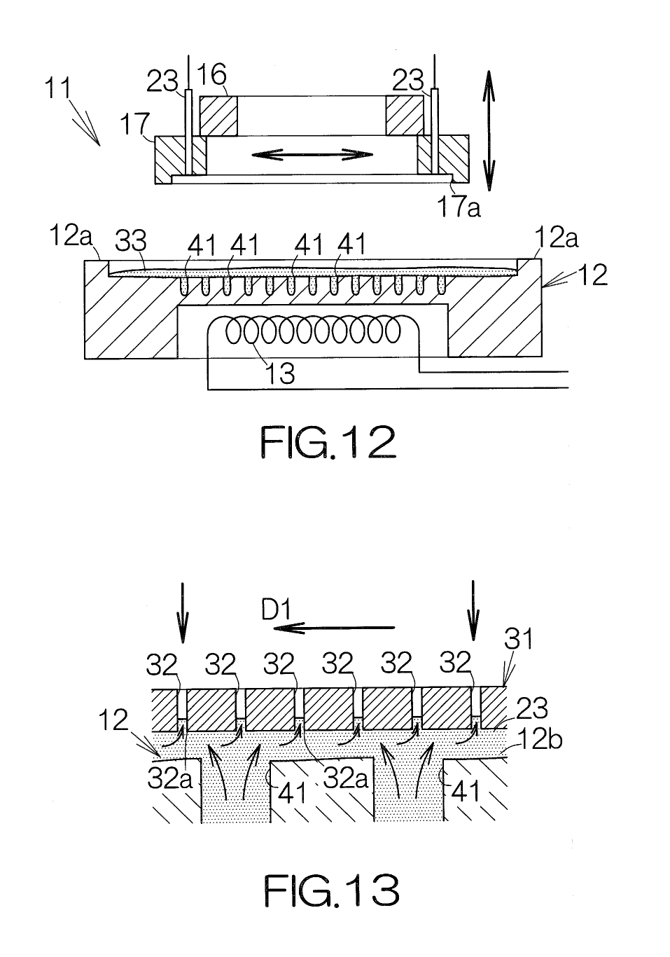

As shown in FIG. 12, the depressions 41 may be bottomed holes arranged on the upper surface of the stage 12 at predetermined intervals, for example. The stage 12 may be made of an elastic material, for example. As shown in FIG. 13, the solder material 33 is stored in the respective depressions 41. In addition, when the flat plate 31 moves in the horizontal direction along the upper surface of the stage 12, the stage 12 elastically deforms around the depressions 41 in response to the urging force of the movable member 16 and/or the horizontal movement of the flat plate 31. Such an elastic deformation serves to push the solder material 33 out of the depressions 41. The openings 32a of the through holes 32 are supplied with the solder material 33 of a sufficient amount in this manner.

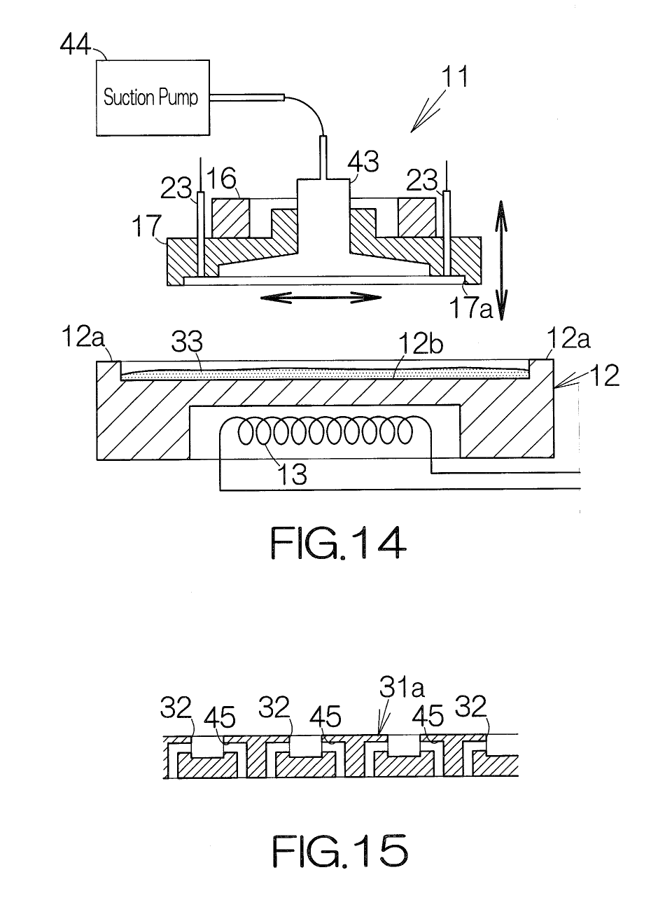

As shown in FIG. 14, the fluid filling apparatus 11 may further comprise a suction nozzle 43. The suction nozzle 43 may be formed integral with the movable head 17. A suction pump 44 is connected to the suction nozzle 43. The suction pump 44 generates negative pressure at the suction nozzle 43. When the flat plate 31 is held in the receiving depression 17a, the tip end of the suction nozzle 43 is received on the front surface of the flat plate 31. The fluid filling apparatus 11 allows generation of negative pressure within the through holes 32 when the through holes 32 are filled with the solder material 33. The through holes 32 are thus filled with the solder material 33 with a higher reliability. Even if the through holes 32 have a smaller diameter, for example, the through holes 32 are reliably filled with the solder material 33 by use of the negative pressure.

As shown in FIG. 15, bent sections 45 may be defined in the through holes 32 of a flat plate 31a. The bent section 45 is designed to extend in parallel with the front and back surfaces of the flat plate 31a. Here, a pair of the through hole 32 extending from the back surface of the flat plate 31a are joined to each other at the respective bent sections 45. The through hole 32 then extends to the front surface of the flat plate 31a. The aforementioned fluid filling apparatus 11 allows the solder material 33 to reliably enter the through holes 32, namely the bent sections 45, based on relative movement between the flat plate 31a and the solder material 33. The through holes 32 of the flat plate 31a are thus reliably filled with the solder material 33.

The fluid filling apparatus 11 may employ any combination of the aforementioned flat surface 12b, depressions 41 and suction nozzle 43. For example, the suction nozzle 43 may be combined with the fluid filling apparatus 11 shown in FIG. 1.

The fluid may be made of a light setting resin material, an oil wax or an electrically-conductive paste including an electrically-conductive filler, for example. The light setting resin material includes an ultraviolet setting resin material, for example. In the case where an ultraviolet setting resin material is employed as the fluid, a light waveguide is formed in the through hole 32 of the flat plate 31 when the through hole 32 is filled with the fluid, for example. The electrically-conductive paste includes a silver paste, for example.

Likewise, the fluid may be made of a material capable of causing phase change between solid state and fluid state in response to application of pressure, chemicals, a chemical reaction, or the like. In this case, a mechanism may be incorporated in the fluid filling apparatus 11 to allow the material to change between solid state and fluid state. Such a mechanism may depend on the kind of the material. The electrothermal coil 13 may be omitted.

The urging force of the movable member 16 or the movable head 17, the speed of the horizontal movement of the movable head 17, the speed of the rotation of the movable head 17, the speed of the horizontal movement of the stage 12, and the speed of the rotation of the stage 12 may be adjusted depending on a predetermined factor or factors. Such predetermined factors include the kind and viscosity of a material which is used as the fluid, the diameter and depth of the through holes 32 of the flat plate 31, and the like.

What is claimed is:

1. A fluid filling apparatus comprising:
a stage defining a surface receiving a fluid spreading over the surface of the stage for receiving a plate; and
a driving mechanism driving the plate along the surface of the stage for relative movement between the fluid and through holes formed in the plate, the through holes opening to the fluid.

2. The fluid filling apparatus according to claim 1, wherein depressions are defined on the surface of the stage.

3. The fluid filling apparatus according to claim 2, wherein the stage is made of an elastic material.

4. The fluid filling apparatus according to claim 1, wherein a bent section is defined in at least one of the through holes.

5. A fluid filling apparatus comprising:
a stage defining a surface receiving a fluid spreading over the surface of the stage for receiving a plate;
an urging member urging the plate toward the surface of the stage; and
a driving mechanism driving the stage for relative movement between the fluid and through holes formed in the plate, the through holes opening to the fluid.

6. A method of filling, comprising:
setting a plate on a fluid spreading over a surface of a stage; and
generating relative movement between the fluid and through holes formed in the plate while urging the plate toward the surface of the stage, the through holes opening to the fluid.

7. A method of making a product, comprising:
setting a solid member on a filling material having a predetermined viscosity; and
generating relative movement between the filling material and through holes formed in the solid member while urging the solid member against the filling material, the through holes opening to the filling material.
